(19) United States
(12) Patent Application Publication
(10) Pub. No.: US 2005/0251315 A1
(43) Pub. Date: Nov. 10, 2005

(54) Vehicle speed ratio control

(75) Inventors: Hiroyasu Tanaka, Zama-shi (JP); Takeshi Oohori, Zama-shi (JP); Manabu Yamanaka, Yokohama-shi (JP)

Correspondence Address: FOLEY AND LARDNER;SUITE 500, 3000 K STREET NW, WASHINGTON, DC, 20007, US

(73) Assignee: JATCO Ltd

(21) Appl. No.: 11/107,989

(22) Filed: Apr. 18, 2005

(30) Foreign Application Priority Data
Apr. 22, 2004 (JP) 2004-126321

(51) Int. Cl. G06F 7/00

(52) U.S. Cl. 701/51

(57) ABSTRACT

A controller (1) feedback controls a speed ratio of an automatic transmission (101) based on the rotation speed signal from a rotation speed sensor (26, 27) which detects the rotation speed of the automatic transmission (101). The controller (1) calculates a noise level in the rotation speed signal by adding integral processing and differential processing to the rotation speed signal (S1, S2). When the noise level is less than a first threshold value (Rsh1), the system is functioning normally, and when the noise level is equal to or greater than a second threshold value (Rsh2) larger than the first threshold value (Rsh1), the rotation speed sensor (26, 27) has a fault. When the noise level is between the first and second threshold values (Rsh1, Rsh2), the rotation speed sensor (26, 27) is under the influence of noise, and speed ratio control is stabilized by maintaining the speed ratio without variation.

### FIELD OF THE INVENTION

This invention relates to vehicle transmission fail-safe control.

### BACKGROUND OF THE INVENTION

Regarding fail-safe control of vehicle transmission, Tokkai Hei 8-338296 published by the Japan Patent Office in 1996 discloses a fault diagnosis device for the common groundwire of various sensors including a rotation speed sensor with which a vehicle transmission is provided.

### SUMMARY OF THE INVENTION

In the prior art, it was impossible to deal suitably with noise mixed with sensor detection signals due to external noise sources, or noise due to faulty wiring contacts. Specifically, if noise becomes mixed with detection signals from rotation speed sensors which detect the output rotation of an automatic transmission representing the vehicle speed, the rotation speed sensor may input a low vehicle speed to the controller of the automatic transmission although the actual vehicle speed may be high. In that case, the controller shifts the speed ratio of the automatic transmission to a ratio suited for low speed, so the engine rotation speed rises excessively, the driver experiences an uncomfortable feeling and vehicle driving performance is impaired. Such a noise may occur in the sensor detection signal even if the sensor common groundwire is functioning normally.

It is therefore an object of this invention to prevent malfunction of an automatic transmission due to noise contamination of the detection signal of a rotation speed sensor.

In order to achieve the above object, this invention provides a vehicle speed ratio control device which feedback controls a speed ratio of an automatic transmission based on an output signal of a rotation speed sensor which detects a rotation speed of the automatic transmission. The control device comprises a programmable controller programmed to calculate a rotation speed noise level from the output signal of the rotation speed sensor, determine, if the noise level is less than a first threshold value, that the rotation speed sensor is functioning normally, determine, if the noise level is equal to or greater than a second threshold value which is larger than the first threshold value, that the rotation speed sensor has a fault, determine, if the noise level is equal to or greater than the first threshold value, but less than the second threshold value, that the rotation speed sensor is under the influence of noise, and perform a different speed ratio control depending on the determination result.

This invention also provides a control method which feedback controls the speed ratio of the above automatic transmission. The control method comprises calculating a rotation speed noise level from the output signal of the rotation speed sensor, determining, if the noise level is less than a first threshold value, that the rotation speed sensor is functioning normally, determining, if the noise level is equal to or greater than a second threshold value which is larger than the first threshold value, that the rotation speed sensor has a fault, determining, if the noise level is equal to or greater than the first threshold value, but less than the second threshold value, that the rotation speed sensor is under the influence of noise, and performing a different speed ratio control depending on the determination result.

The details as well as other features and advantages of this invention are set forth in the remainder of the specification and are shown in the accompanying drawings.

### BRIEF DESCRIPTION OF THE DRAWINGS

FIG. 1 is a schematic diagram of a vehicle speed ratio controller according to this invention.

FIG. 2 is a timing chart describing a difference of sensor output characteristics when noise is present and there is a fault.

FIG. 3 is a block diagram describing the functions of a controller according to this invention.

FIG. 4 is a flowchart for the purpose of describing a speed ratio fail-safe control routine performed by the controller.

### DESCRIPTION OF THE PREFERRED EMBODIMENTS

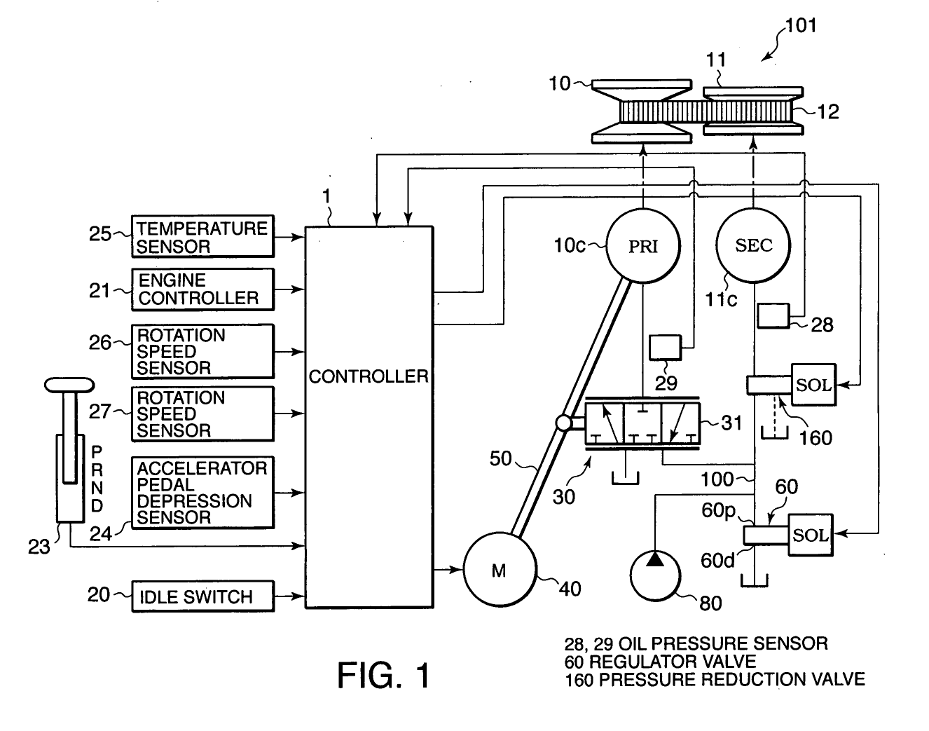

Referring to FIG. 1 of the drawings, a V-belt type continuously variable transmission (CVT) 101 for vehicles comprises a primary pulley 10 connected to an input shaft, a secondary pulley 11 connected to an output shaft, and a V-belt 12 looped around the pulleys. The input shaft is connected to an internal combustion engine with which the vehicle is provided, and the output shaft is connected to vehicle drive wheels.

The primary pulley 10 varies the groove width which grips the V-belt depending on the oil pressure (hereinafter referred to as primary pressure) acting on a primary pulley cylinder 10c. The secondary pulley 11 varies the groove width which grips the V-belt depending on the oil pressure (hereinafter referred to as secondary pressure) acting on a secondary pulley cylinder 11c.

The speed ratio of the CVT 101, and the contact frictional force between the V-belt 12 and pulleys 10, 11, are controlled via an oil pressure control circuit which responds to command signals from the controller 1.

The oil pressure control circuit comprises an oil pressure pump 80, a regulator valve 60 which generates a line pressure from the discharge pressure of the oil pressure pump 80, a speed ratio control valve 30 which controls the primary pressure and a pressure reduction valve 160 which controls the secondary pressure.

The speed ratio control valve 30 is a spool valve which connects the primary pulley cylinder 10c to the oil pressure pump 80 and a drain according to the displacement of a spool 31. One end of the spool 31 is connected to an intermediate part of a servolink 50. A step motor 40 for varying the displacement of the spool 31 is connected to one end of the servolink 50. A link mechanism which feeds back the groove width of the primary pulley 10 is connected to the other end of the servolink 50.

A regulator valve 60, which is a two-way linear solenoid valve, adjusts the output pressure of the oil pump 80 to a line pressure PL depending on the line pressure signal output from the controller 1.

The line pressure PL is supplied to both the speed ratio control valve 30 and pressure reduction valve 160.

The speed ratio between the primary pulley and secondary pulley 10, 11 varies with the primary pressure and secondary pressure. The controller 1 determines a target speed ratio of the CVT 101 based on vehicle running conditions, i.e., the vehicle speed and the depression amount of an accelerator pedal operated by the driver of the vehicle, and determines target values of the primary pressure and secondary pressure according to the target speed ratio. The primary pressure is then controlled to its target value by the output of the primary pressure control signal supplied to the step motor 40, and the secondary pressure is controlled to its target value by the output of the secondary pressure control signal supplied to the pressure reduction valve 160.

When the step motor 40 displaces the spool 31 according to the primary pressure control signal from the controller 1, the speed ratio control valve 30 adjusts the primary pressure by connecting the line pressure and drain to the primary pulley cylinder 10c in a ratio depending on the displacement position of the spool 31. When the primary pressure reaches the target value, the spool 31 interrupts inflow/outflow of oil pressure to and from the primary pulley cylinder 10c so as to maintain the primary pressure at the target pressure by a feedback movement of the servolink 50. On the other hand, adjustment of the secondary pressure by the pressure reduction valve 160 takes place by open loop control according to the secondary pressure control signal from the controller 1.

In order to perform the above control by the controller 1, detection data signals are input from various sensors. These sensors include a primary pulley rotation speed sensor 26 which detects the rotation speed of the primary pulley 10, a secondary pulley rotation speed sensor 27 which detects the rotation speed of the secondary pulley 11, an oil pressure sensor 28 which detects the secondary pressure acting on the secondary pulley cylinder 11c, an oil pressure sensor 29 which detects the primary pressure acting on the primary pulley cylinder chamber 10c, an inhibitor switch 23 which detects the selection range of a select lever which the driver of the vehicle operates, an accelerator pedal depression sensor 24 which detects the depression amount of the accelerator pedal, an idle switch 20 which detects that the accelerator pedal is released, and a temperature sensor 25 which detects the oil temperature of the CVT 101. The secondary pulley rotation speed detected by the secondary pulley rotation speed sensor 27 is used also as a signal representing the vehicle speed.

An input shaft rotation torque is also input to the controller 1 from an engine controller 21 which controls the internal combustion engine.

The controller 1 is constituted by a microcomputer comprising a central processing unit (CPU), read-only memory (ROM), random access memory (RAM) and input/output interface (I/O interface). The controller may also comprise plural microcomputers.

In addition to the above speed ratio control of the CVT 101, the controller 1 diagnoses any abnormality in the output signals from the rotation speed sensors 26, 27 relating to speed ratio control, and performs fail-safe control of the CVT 10 if an abnormality is determined in any of the output signals.

Noise may occur in the output signals from the rotation speed sensors 26, 27 due to the following causes:
(1) Faulty wiring of the sensor connectors,
(2) Vehicle running on a punishing road,
(3) Unevenness in the signal due to missing teeth in the gear with which the rotation speed sensor 26 or 27 is provided,
(4) Electromagnetic wave noise due to operation of a high-frequency actuator installed in the vicinity of the rotation speed sensor 26 or 27, and
(5) Variation in road surface conditions.

Regarding item (3), the rotation speed sensor comprises a sensor body which responds to the passage of the gear teeth, the rotation speed of the gear being detected from the interval between sensor responses. If any of the gear teeth is damaged, the interval between sensor responses will be correspondingly greater, and an unevenness will appear in the output signal.

Regarding item (5), when for example the road surface changes from a wet road to a dry road, noise may occur in the system.

Items (1) and (3) are noise due to a fault in the sensor 26 (27) itself, whereas items (2), (4) and (5) are noise which may occur even when the rotation speed sensor is working normally.

If there is a break in the signal cable connecting the rotation speed sensor 26 (27) and the controller 1, a signal will not be output from the rotation speed sensor 26 (27). Also, if the signal cable has short-circuited, the output signal will always be a constant value. Therefore, these cases can easily be distinguished from the above noise.

However, noise due to items (1)-(5) may occur irregularly at any time.

The controller 1, in addition to speed ratio control when the output signal of the rotation speed sensor 26 (27) is normal, and fail-safe control of the speed ratio when the rotation speed sensor 26 (27) has a fault, also performs a third speed ratio control when noise is mixed with the output signal of the rotation speed sensor 26 (27). Hereafter, this will be referred to as caution control.

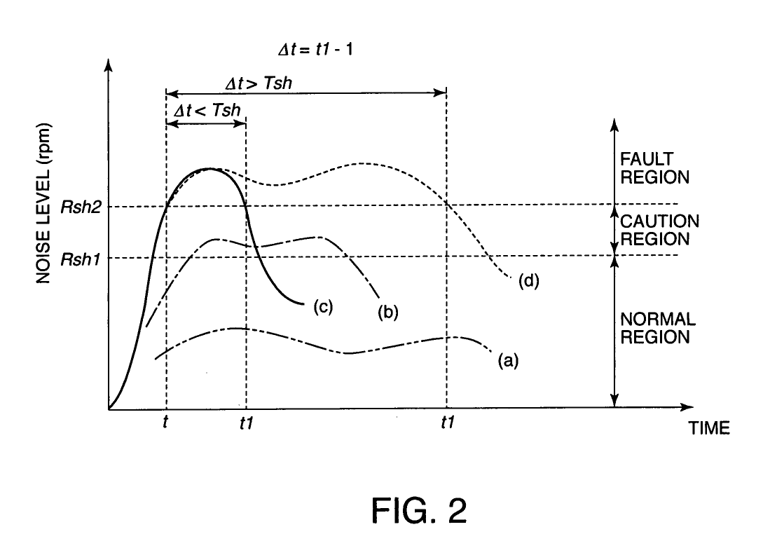

Referring to FIG. 2, the caution control region is divided according to the magnitude of the noise. The ordinate of FIG. 2 is the noise level, and the abscissa is the elapsed time. The noise level means the variation amount of the output signal. In the figure, the region where the noise level is below a first threshold value Rsh1 is set as a normal region. The region where the noise level exceeds a second threshold value Rsh2 is a set as a fault region. The region from the first threshold value Rsh1 to the second threshold value Rsh2 is set as a caution region.

The controller 1 determines the control to be performed based on the region reached by the noise level of the rotation speed sensor 26 (27), and the time for which the noise level in the region reached has continued.

In characteristic (a) of the figure, the peak of the noise level of the output signal of the rotation speed sensor 26 (27) is always below the first threshold value Rsh1. When the output signal of the rotation speed sensor 26 (27) corresponds to the characteristic (a), the controller 1 applies normal control to the speed ratio.

In characteristic (b), the peak of the noise level of the output signal of the rotation speed sensor 26 (27) is above the first threshold value Rsh1, but does not reach the second threshold value Rsh2. In other words, the peak of the noise level of the output signal of the rotation speed sensor 26 (27) lies within the caution region. When the output signal of the rotation speed sensor 26 (27) corresponds to characteristic (b), caution control is applied to the speed ratio.

In characteristic (c), the peak of the noise level of the output signal of the rotation speed sensor 26(7) exceeds the second threshold value Rsh2. However, a continuation time Δt of the state where the peak of the noise level exceeds the second threshold value Rsh2 is shorter than a threshold value Tsh of the continuation time. When the output signal of the rotation speed sensor 26 (27) corresponds to the characteristic (c), caution control is applied to the speed ratio.

In characteristic (d), the peak of the noise level of the output signal the rotation speed sensor 26 (27) exceeds the second threshold value Rsh2, and the continuation time At also exceeds the threshold value Tsh. When the output signal of the rotation speed sensor 26 (27) corresponds to characteristic (d), the controller 1 applies fault control to the speed ratio.

Next, the normal control, fault control and caution control applied to the speed ratio will be described.

During normal control, the controller I feedback controls the speed ratio of the CVT 101 based on the output signals of the rotation speed sensors 26, 27, to the target speed ratio depending on the vehicle speed and accelerator pedal depression amount. Herein, the ratio of the input rotation speed of the CVT 101 detected by the rotation speed sensor 26 and the output rotation speed of the CVT 101 detected by the rotation speeds sensor 27, is the real speed ratio.

During fault control, the controller 1 performs open loop control of the speed ratio of the CVT 101 to the target speed ratio based on the vehicle speed and accelerator pedal depression amount without using the output signals of the rotation speed sensors 26, 27.

During caution control, the controller 1 fixes the speed ratio of the CVT 101 to the speed ratio at the time it is decided to perform caution control. Specifically, the speed ratio control valve 30 and pressure reduction valve 160 are controlled so that the primary pressure and secondary pressure at the time it is decided to perform caution control are maintained as they are.

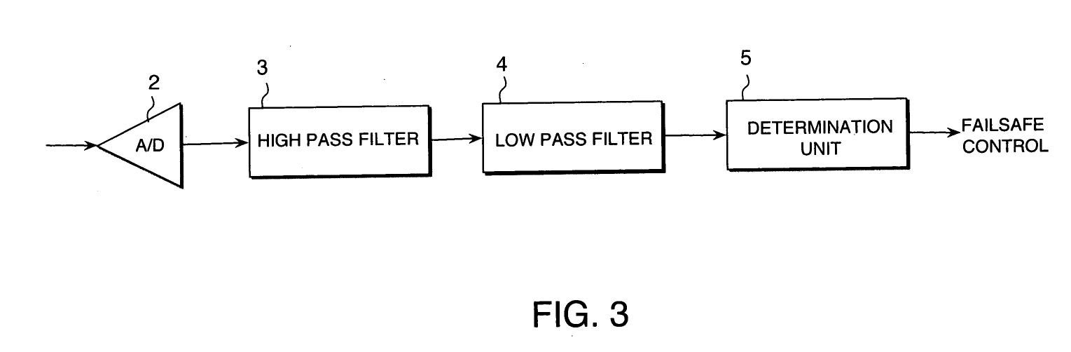

Referring to FIG. 3, to perform the aforesaid control, the controller 1 comprises an A/D converter 2 which converts the analog signal output by the rotation speed sensor 26 (27) to a digital signal, a high pass filter 3 which integrates the converted digital signal over different intervals, a low pass filter 4 which outputs a noise level by differentiating the signal processed by the high pass filter 3, and a determination unit 5 which performs the region determination described in regard to FIG. 3 from the noise level. The blocks with reference symbols in the figure represent the functions of the controller 1 as virtual units, and do not exist physically.

The noise due to the aforesaid factors (1), (2), (4), (5) has a higher frequency than the signal which is generally output by the rotation speed sensor 26 (27) in the normal state. Hence, the noise is extracted by passing the output signal of the rotation speed sensor 26 (27) through the high pass filter 3. On the other hand, if there is unevenness in the signal due to missing gear teeth described in item (3), the frequency is lower than the signal output by the rotation speed sensor 26 (27) in the normal state. Hence, the noise is extracted by passing the signal through the low pass filter 4.

As a result, the output signal of the low pass filter 4 represents a noise level which is the sum of high frequency noise and low frequency noise. The controller 1 performs the following fail-safe control using the noise level obtained in this way.

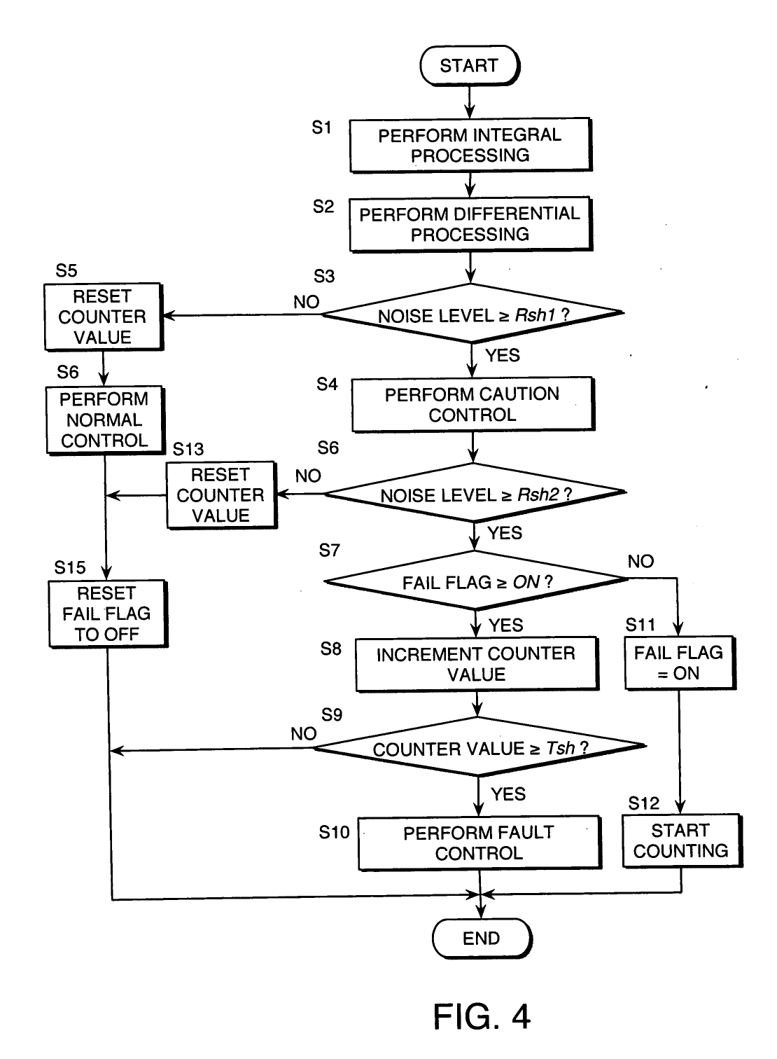

Referring to FIG. 4, the fail-safe control routine for the speed ratio of the CVT 101 performed by the controller 1 using the above function will now be described. The controller 1 performs this routine at an interval of ten milliseconds during the running of the internal combustion engine.

In the following description, the case will be taken of the control performed by the controller 1 regarding the noise in the output signal from the rotation speed sensor 27, but the controller 1 performs an identical control regarding the output signal from the rotation speed sensor 26.

First, in a step S1, the controller 1 calculates the noise level of the output signal of the rotation speed sensor 27 by adding integral processing corresponding to the high pass filter 3 described above to the output signal of the rotation speed sensor 27 after A/D conversion.

In a next step S2, the controller 1 calculates the noise level of the output signal of the rotation speed sensor 27 by adding the differential processing corresponding to the low pass filter 4 described above to the signal processed in the step S1.

In a next step S3, the controller 1 compares the noise level with a first threshold value Rsh1. The first threshold value Rsh1 is a value corresponding to the noise level which could occur due to bad vehicle road conditions even if the rotation speed sensor 27 is functioning normally. In other words, the first threshold value Rsh1 corresponds to the maximum value of a time variation amount of the output signal from the rotation speed sensor 27 when it is functioning normally and vehicle running conditions are within a design range for normal running. The first threshold value Rsh1 is set by experiment or simulation beforehand.

If the noise level is equal to or greater than the first threshold value Rsh1, the controller 1, in a step S4, controls the speed ratio of the CVT 101 by applying the aforesaid caution control. In other words, the speed ratio control valve 30 and pressure reduction valve 160 are controlled so that the speed ratio at the current time continues unchanged.

If the noise level is less than the first threshold value Rsh1, the controller 1, in a step S5, resets a counter value to zero, and in a step S14, controls the speed ratio of the CVT 101 by applying normal control. The counter value will be described later.

When caution control is performed in the step S4, the controller 1, in a next step S6, compares the noise level with a second threshold value Rsh2. The second threshold value Rsh2 is a value for determining a fault in the rotation speed sensor 27. It is a noise level which can determine that a fault has occurred in the rotation speed sensor 27 without any error, and is a larger value than the first threshold value Rsh1. In other words, the second threshold value Rsh2 corresponds to a time variation amount of the output signal which is not generated due to noise. The second threshold value Rsh2 is also set by experiment or simulation beforehand.

If the noise level is less than the second threshold value Rsh2, the controller 1, in a step S13, resets the counter value to zero.

After the processing of the aforesaid step S14 or step S13, the controller 1, in a step S15, resets a fail flag to OFF. After the processing of the step S15, the controller 1 terminates the routine.

On the other hand, if the noise level is equal to or greater than the second threshold value Rsh2, the controller 1, in a step S7, determines whether or not the fail flag is ON. The fail flag is set to ON when the noise level is equal to or greater than the second threshold value Rsh2, and is reset to OFF when the noise level falls below the second threshold value Rsh2. The initial value of the fail flag is OFF.

Therefore, when the noise level is determined to be equal to or greater than the second threshold value Rsh2 in the step S6 for the first time, the fail flag is OFF. In this case, the controller 1 performs the processing of the steps S11, S12.

In the step S 11, the controller 1 resets the fail flag to ON, and in a step S12, starts counting the counter value. The initial value of the counter is zero. Also, if the noise level is less than the second threshold value Rsh2, the counter value is reset to zero in the step S5 or step S13 as described above. Therefore, in the step S12, the counter value when the counter starts counting is always zero. After the processing of the step S12, the controller 1 terminates the routine.

On the other hand, if the fail flag is ON in the step S7, it shows that the state where the noise level exceeds the second threshold value Rsh2 is continuing after execution of the immediately preceding routine. In this case, in a step S8, the controller 1 increments the counter value. The counter value therefore represents the continuation time for which the noise level is equal to or greater than the second threshold value Rsh2.

In a next step S9, the controller 1 compares the counter value with a time threshold value Tsh.

If the counter value is less than the threshold value Tsh, the controller 1 immediately terminates the routine.

If the counter value is equal to or greater than the threshold value, the controller 1, in a step S10, controls the speed ratio of the CVT 101 by applying the aforesaid fault control. After the processing of the step S10, the controller 1 terminates the routine.

By repeatedly performing the aforesaid routines, it is possible to distinguish between a fault in the rotation speed sensor 27 and temporary noise from the noise level of the output signal of the rotation speed sensor 27, and to apply a different speed ratio control of the CVT 101 depending on the determination result. Due to this invention, therefore, inappropriate response of the speed ratio of the CVT 101 due to noise in the rotation speed signal is prevented, and stable speed ratio control is realized. Also, due to this invention, the precision of fault detection in the rotation speed sensor 27 is improved.

In the aforesaid embodiment, this invention was applied to the detection signal of the rotation speed sensor 27, but it may be applied also to the detection signal of the rotation speed sensor 26.

Further, this invention is preferably applied to both the rotation speed sensors 26 and 27. Specifically, the noise level is calculated respectively for the rotation speed sensors 26, 27, and the controller 1 performs the processing of the step S4 if one of the noise levels is equal to or greater than the first threshold value Rsh1 in the step S3. Also, the controller 1 performs the processing of the step S8 if one of the noise levels is equal to or greater than the second threshold value Rsh2 in the step S6. The remaining steps are identical to the processing already described.

The contents of Tokugan 2004-126321, with a filing date of Apr. 22, 2004 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in the aforesaid embodiment, this invention was applied to speed ratio control of the CVT 101, but it may be applied also to speed ratio control of a conventional automatic transmission.

The embodiments of this invention in which an exclusive property or privilege is claimed are defined as follows:

1. A vehicle speed ratio control device which feedback controls a speed ratio of an automatic transmission based on an output signal of a rotation speed sensor which detects a rotation speed of the automatic transmission, comprising:
a programmable controller programmed to:
calculate a rotation speed noise level from the output signal of the rotation speed sensor;
determine, if the noise level is less than a first threshold value, that the rotation speed sensor is functioning normally;
determine, if the noise level is equal to or greater than a second threshold value which is larger than the first threshold value, that the rotation speed sensor has a fault;
determine, if the noise level is equal to or greater than the first threshold value, but less than the second threshold value, that the rotation speed sensor is under the influence of noise; and
perform a different speed ratio control depending on the determination result.

2. The control device as defined in claim 1, wherein the controller is further programmed to, if the rotation speed sensor is under the influence of noise, perform speed ratio control so that the speed ratio does not vary.

3. The control device as defined in claim 1, wherein the controller is further programmed to, when the rotation speed sensor has a fault, perform speed ratio control by open loop control not based on the output signal from the rotation speed sensor.

4. The control device as defined in claim 1, wherein the first threshold value corresponds to an upper limit of the time variation amount of the signal output when the rotation speed sensor is functioning normally and the vehicle is running normally.

5. The control device as defined in claim 1, wherein the second threshold value is larger than the first threshold value.

6. The control device as defined in claim 5, wherein the second threshold value corresponds to the time variation amount of the output signal which cannot be output due to noise.

7. The control device as defined in claim 1, wherein the controller is further programmed to calculate the noise level by adding integral processing and differential processing to the output signal from the rotation speed sensor.

8. A vehicle speed ratio control device which feedback controls a speed ratio of an automatic transmission based on an output signal of a rotation speed sensor which detects a rotation speed of the automatic transmission, comprising: means for calculating a rotation speed noise level from the output signal of the rotation speed sensor;
means for determining, if the noise level is less than a first threshold value, that the rotation speed sensor is functioning normally;
means for determining, if the noise level is equal to or greater than a second threshold value which is larger than the first threshold value, that the rotation speed sensor has a fault;
means for determining, if the noise level is equal to or greater than the first threshold value, but less than the second threshold value, that the rotation speed sensor is under the influence of noise; and
means for performing a different speed ratio control depending on the determination result.

9. A vehicle speed ratio control method which feedback controls a speed ratio of an automatic transmission based on an output signal of a rotation speed sensor which detects a rotation speed of the automatic transmission, comprising:
calculating a rotation speed noise level from the output signal of the rotation speed sensor;
determining, if the noise level is less than a first threshold value, that the rotation speed sensor is functioning normally;
determining, if the noise level is equal to or greater than a second threshold value which is larger than the first threshold value, that the rotation speed sensor has a fault;
determining, if the noise level is equal to or greater than the first threshold value, but less than the second threshold value, that the rotation speed sensor is under the influence of noise; and
performing a different speed ratio control depending on the determination result.
